(19) United States
(12) Patent Application Publication
(10) Pub. No.: US 2007/0296842 A1
(43) Pub. Date: Dec. 27, 2007

(54) Spiral image capture system

(76) Inventor: Raymond Samuel Connell, Rancho Palos Verdes, CA (US)

Correspondence Address: PATENT LAW OFFICES OF DAVID MILLERS, 1221 Sun Ridge Road, Placerville, CA, 95667, US

(21) Appl. No.: 11/450,161

(22) Filed: Jun. 9, 2006

(51) Int. Cl. H04N 5/335

(52) U.S. Cl. 348/294

(57) ABSTRACT

An image capture system, having image elements arranged in a logarithmic spiral, which makes the information taken from the image for a particular object invariant with both the magnification and rotation of the object thus substantially simplifying both object alignment and the information processing necessary to achieve object recognition, identification, verification or classification.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Because of the great importance of efficient image recognition for a wide variety of purposes including, for example, face recognition, fingerprint recognition and intelligent robotics, there is a large ongoing research and development effort to improve image recognition methods. Up to the present time, all known methods are based on extracting feature information directly from a rectangular format (x-y pixel) image, principally because that is the standard structure of digital images. Typically, various kinds of two-dimensional x-y transforms are employed to compress the image or to extract recognition signatures. However, there is no inherent feature of the x-y pixel format that particularly recommends it as the most efficient one for image recognition purposes. In fact, the x-y pixel format has a substantial disadvantage: An x-y image usually contains a very large amount of irrelevant information that must be processed in order to extract relevant recognition features. At present, an image with good resolution contains on the order of a million pixels corresponding to three to four million digital bytes. Moreover, for reliable recognition, objects must be aligned in at least four dimensions: x, y, scale (magnification) and rotation.

### BRIEF SUMMARY OF THE INVENTION

The present invention takes a completely different approach to the image recognition problem by assuming that, instead of consisting of a rectangular array of constant-size pixels, the image should consist of pixels that geometrically increase in distance and size from a focal center in the manner of a logarithmic spiral as in FIG. 1. The logarithmic spiral, given in polar coordinates r, θ by the equation

r=B exp(A θ) (1)

for constants A and B, has the property that it is self similar (looks identically the same at all scales). This property transfers in a remarkable way to an image consisting of expanding pixels spiraling out from a focal center as a log spiral: By mapping successive spiral pixels into a single one-dimensional data array (as opposed to the two-dimensional data required for x-y images), the information corresponding to an image object becomes invariant with either rotation or relative magnification of the object. Thus, the data array contains the same information independent of the size of the object. For different object sizes or rotations the object data simply translates in position, otherwise unchanged, along the length of the data array.

The self-similarity property described above has significant consequences for the extraction of image recognition information. One consequence is that because spiral pixel size increases with distance from center, only about one to two thousand spiral pixels are necessary to produce a unique and recognizable object image covering the full range of potential object sizes. Also, the image resolution is higher at the center of the image where high resolution is important and lower at the outside edges where resolution matters less with the consequence that identifying details are included along with global identifying information. Another consequence is that object recognition can be achieved independent of object size in an image. And another consequence is that because spiral pixels are larger as the distance from center increases, the spiral capture system is potentially less sensitive to x-y registration than an equivalent x-y formatted capture system.

### BRIEF DESCRIPTION OF THE SEVERAL VIEWS OF THE DRAWING

FIG. 1 shows an image of a face captured by a spiral image capture system comprising 1536 image elements as that image would appear when remapped to the original linear image dimensions.

FIG. 2 shows an image of the same face as in FIG. 1 captured by the same system but with the face at a smaller scale.

FIG. 3 is a graph of the cross-correlation of the data from the images captured in FIG. 1 and FIG. 2.

### DETAILED DESCRIPTION OF THE INVENTION

The present invention is an image capture system for scanning or otherwise collecting optical image data from pixels arranged in the form of a logarithmic spiral. Each spiral pixel is associated with a corresponding element of a data register means such as computer memory or a hardware shift register. While it is desirable to capture image data directly from an image source that has pixels arranged in a logarithmic spiral, it is also practical to generate such pixels from video cameras and digital images that provide data consisting of x-y formatted pixels. In such cases it is necessary to re-map x-y pixels to virtual spiral pixels which exist only in hardware registers or computer memory. To avoid confusion with x-y pixels, these spiral pixels will be called spiral cells.

Efficient image remapping employs a lookup table in x-y format that contains the indexes of spiral cells in a virtual image of the spiral array that would overlay the x-y pixels. Image re-mapping is accomplished by a software program or by firmware that uses the x-y position of every pixel in the input image as an index into the lookup table data array taking into account possible offset in x-y position of the center of the spiral. When a particular pixel position indexes a lookup table location containing the index of a specific spiral cell, the color bytes of that pixel are averaged into the color bytes of the spiral cell at the index location.

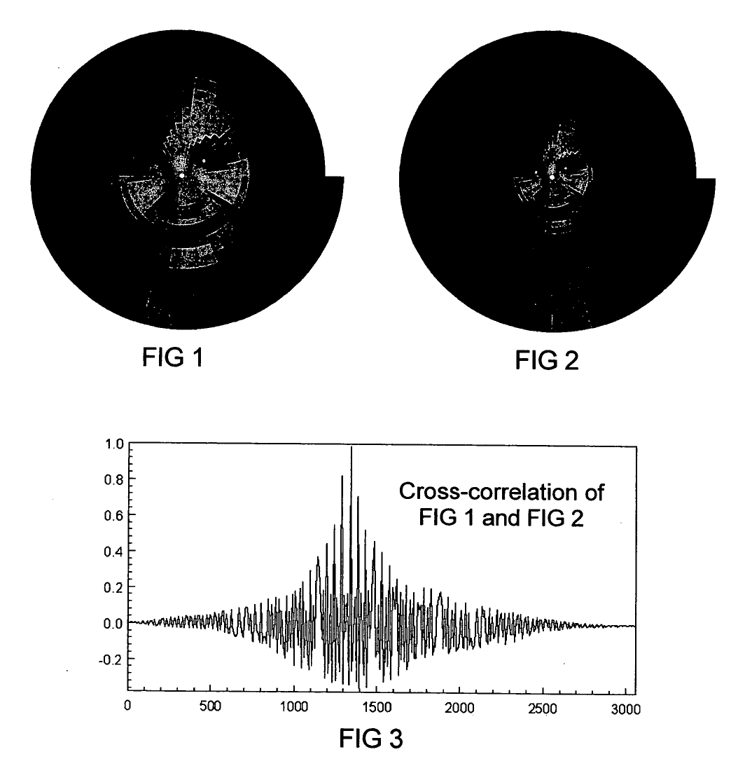

Adequate resolution for recognition of faces, for example, is provided by 48 equal-angle spiral cells in one rotation of the spiral and 32 total spiral rotations. This format produces spiral cells that look approximately rectangular as shown in FIG. 1. However, that is not the only possible combination of angle increment and number of spiral rotations that is effective and, consequently, should be considered as illustrative. Nor is it required that the spiral cells be precisely aligned in angle as they are in FIG. 1. The logarithmic spiral provides a lower and upper boundary that determines the height of a particular spiral cell. Using the values provided above, the lower boundary is defined by the logarithmic spiral equation

r₀=6.3 exp(0.02 θ) (2)

and the upper boundary is defined by

r₁=6.3 exp(0.02(θ+2π)). (3)

To define the angular boundaries of each cell, θ is incremented by the constant value 2π/48. To achieve the result shown in FIG. 1, starting from zero, 1536 such increments defined the spiral cells. A lookup table could be constructed in computer memory by selecting enough empty memory to enclose an image of the spiral overlayed on the x-y format. Then the lookup table is filled by indexing through that memory and determining, by the use of the equations above, which spiral cell index, if any, is to be placed in the x-y table location. That index or a marker value for none would then be inserted into the table x-y location.

To demonstrate the invariance of image object information with object size, spatial derivatives of the data arrays for the two spiral face images in FIG. 1 and FIG. 2 were cross-correlated (FIG. 3). Symmetric first differences dfᵢ for each image cell array f at element i were generated as dfᵢ=(fᵢ₋₁+fᵢ₊₁)/2. With normalization to the autocorrelation maximum of FIG. 1, the cross-correlation in FIG. 3 is smaller by about 0.014734. The main source of this error is a small amount of missing scan in FIG. 2 within the white unscanned area in the center of the image that is included around the central white unscanned area of FIG. 1.

It should be evident that there are many existing methods, too numerous to describe in detail, that could potentially obtain an image with the cell structure visible in FIG. 1. Those methods include the use of mechanical and electronic image scanners, direct imaging devices and devices that re-map image formats. To the extent that the image collected by any such method results in the image cell structure of a logarithmic spiral as described herein or as visible in FIG. 1 upon being re-mapped to the original linear image dimensions, then the mechanism of that method is deemed to be an implementation of the present invention.

While the greatest benefit of the present invention is obtained from image cells all arranged precisely in a logarithmic spiral, it may be necessary to vary that arrangement in specific implementations for specific purposes. That is consistent with the kinds of engineering compromises that are frequently made in practical engineering systems. For that reason, any system of the type described herein which is based on image cells positioned in a progressive outward spiral irrespective of the exact shape of the spiral or of the shape of the individual image cells (which might possibly be connected to a multiplicity of data registers) is considered to be substantially in a logarithmic spiral and is deemed to fall within the scope of the present invention.

The embodiments of the invention in which I claim an exclusive property or privilege are defined as follows:

1. An image capture system for the purpose of object or image recognition, identification, verification or classification comprising:
a source of real or virtual image cells that are arranged substantially in a logarithmic spiral
and a readable, multiple-element data register means, each element of which captures the data from an individual image cell.

2. The image capture system of claim 1 wherein the source of image cells is a light sensitive integrated circuit means containing light sensitive elements arranged substantially in a logarithmic spiral.

3. The image capture system of claim 1 wherein the source of image cells is an image scanning means that accumulates image elements from substantially a logarithmic spiral around the image center.

4. The image capture system of claim 1 wherein the source of image cells is a computer program means that re-maps pixels in some other format to image cells substantially in a logarithmic spiral.

5. The image capture system of claim 1 wherein the source of image cells is an integrated circuit means that re-maps pixels in some other format to image cells substantially in a logarithmic spiral.
